(19) United States
(12) Patent Application Publication
(10) Pub. No.: US 2006/0050441 A1
(43) Pub. Date: Mar. 9, 2006

(54) Recording and/or reproducing apparatus suspension assembly and method

(75) Inventor: Tae-sik Kang, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/221,933

(22) Filed: Sep. 9, 2005

(30) Foreign Application Priority Data
Sep. 9, 2004 (KR) 10-2004-0072108

(51) Int. Cl. G11B 5/48

(52) U.S. Cl. 360/245.1

(57) ABSTRACT

A recording and/or reproducing apparatus including a suspension assembly. The suspension assembly may include a load beam coupled to one end of a swing arm, a flexure coupled to the load beam and supporting a slider, and a dimple formed along a surface of the flexure, facing the load beam, enabling the flexure to move freely within desired bounds.

### CROSS-REFERENCE TO RELATED APPLICATIONS

This application claims the priority benefit of Korean Patent Application No. 10-2004-0072108, filed on Sep. 9, 2004, in the Korean Intellectual Property Office, the disclosure of which is incorporated herein in its entirety by reference.

### BACKGROUND OF THE INVENTION

1. Field of the Invention

Embodiments of the present invention relate to a recording and/or reproducing apparatus, and more particularly, to a disk drive including a suspension assembly having a dimple that enables an internal flexure to move freely within desired bounds.

2. Description of the Related Art

Hard disk drives (HDDs), which may store information in computers, record and/or reproduce data to/from a disk using a read/write head.

FIG. 1 illustrates a partial perspective view of a conventional disk drive.

Referring to FIG. 1, the conventional disk drive may include a disk 1, acting as a data recording medium, a spindle motor 2 rotating the disk 1, and an actuator moving a read/write head (not shown) to a desired position on the disk 1. The read/write head records predetermined data to the disk 1 and/or reproduces data from the disk 1.

In detail, the actuator 3 can include a swing arm 4, rotating due to a rotational force produced by a voice coil motor (VCM, not shown), and a suspension assembly 5 installed on an end of the swing arm 4. The suspension assembly 5 can elastically bias an air bearing slider 8, on which the read/write head is mounted, toward a surface of the disk 1.

In further detail, the suspension assembly 5 can include a load beam 6 coupled to an end of the swing arm 4, a flexure 7 extending from a rear surface of the load beam 6, and the air bearing slider 8 coupled to a rear surface of the flexure 7. The flexure 7 can support the slider 8 on which the read/write head is mounted. The slider 8, with the read/write head thereon, can fly at a predetermined height above the surface of the disk 1 due to a lifting force produced when the disk 1 rotates, such that a predetermined distance is maintained between the read/write head and the surface of the disk 1.

Conventionally, a dimple 9, protruding toward the flexure 7, is formed on the load beam 6 and provides a predetermined elastic force to the flexure 7. In this structure, the flexure 7 may move freely, such that smooth roll and pitch motions of the slider 8 attached to the flexure 7 can potentially be controlled.

FIGS. 2A-2B illustrate a vertical sectional view of the suspension assembly of the conventional disk drive shown in FIG. 1, illustrating the dimple and the flexure normally contacting each other. FIGS. 3A-3B illustrate a vertical sectional view of the suspension assembly of the conventional disk drive shown in FIG. 1, illustrating a contact position between the dimple and the flexure having changed. Since the same reference numerals denote the same elements in FIGS. 1 through 3B, a detailed explanation of the same elements will be further omitted.

Referring to FIGS. 2A-2B and 3A-3A, the dimple 9 of the suspension assembly 5 of the conventional disk drive has a semi-circular shape and is formed on the rear surface of the load beam 6. The dimple 9 transfers a load transferred from the suspension assembly 5 to the slider 8, coupled to the rear surface of the flexure 7, as the flexure 7 extends from the rear surface of the load beam 6. To obtain smooth load transfer, the dimple 9 applies a force F to a central portion of the slider 8. Accordingly, the dimple 9 preferably is continuously in contact with a predetermined portion of the flexure 7.

However, there is often contact separation between the dimple 9 and the flexure 7 due to external shocks or the like. As shown in FIGS. 3A and 3B, a contact position between the dimple 9 and the flexure 7 may have changed. If such a position change occurs, the point of action for the force F, applied to the slider 8, changes a distance dX and/or dY from a central portion of the slider 8 where the force F is preferably applied. Due to such a position change, a moment of the force applied to the slider 8 also changes, leading to changes in attitudes (i.e., a flying height, a pitch angle, and a roll angle) of the slider 8. Accordingly, the slider 8 cannot fly and move smoothly, as desired. In addition, the head and the disk may also be damaged due to a contact therebetween upon such a position change.

### SUMMARY OF THE INVENTION

Embodiments of the present invention provide a suspension assembly having a dimple preventing a point of action for a force applied from a load beam from changing even though contact and separation between the dimple and an opposing surface may occur.

To achieve the above and/or other aspects and advantages, embodiments of the present invention include a suspension assembly for a recording and/or reproducing apparatus, to be installed on a swing arm to elastically bias an air bearing slider with a read/write head thereon toward a surface of a medium, the suspension assembly including a load beam coupled to the swing arm, a flexure, coupled to the load beam and supporting the slider, having freedom of movement separate from the load beam, with the flexure including a dimple, and the dimple being on a surface of the flexure, separate from the load beam, facing the load beam.

The dimple may protrude a predetermined height from the surface of the flexure toward the load beam. In addition, the dimple may include a vertical section with a predetermined curvature and/or a vertical section that is semi-circular or semi-oval. Further, upon movement of the flexure, the dimple is point-contactable with the load beam.

The dimple may be integrally formed with the flexure. Alternatively, the dimple may be separate from an integral structure of the flexure, but fixed to the flexure.

Further, the recording and/or reproducing apparatus may be a disk drive and the medium is a disk.

To achieve the above and/or other aspects and advantages, embodiments of the present invention include a suspension assembly for a recording and/or reproducing apparatus, including a load beam disposed on a swing arm, a flexure, coupled to the load beam, having freedom of movement separate from the load beam, an air bearing slider, disposed on the flexure, including a read/write head, and a dimple, separate from the load beam, coincidently moving with the slider, such that a position relation between the dimple and the slider is maintained constant.

The dimple may coincidently move with the flexure and the slider.

The dimple and the slider may be on the flexure to enable the coincident movement of the dimple, slider, and flexure.

The dimple may be integrally formed with the flexure.

The dimple may be separate from an integral structure of the flexure, but fixed to the flexure, facing the load beam.

The dimple may also protrude a predetermined height from the flexure toward the load beam. The dimple may have a vertical section with a predetermined curvature and/or a vertical section that is substantially semi-circular or semi-oval.

The dimple may also be point-contactable with a surface of the load beam.

The recording and/or reproducing apparatus may also be a disk drive.

To achieve the above and/or other aspects and advantages, embodiments of the present invention include a recording and/or reproducing apparatus, including a medium, a read/write head to record and/or reproduce data to/from the medium, and a suspension assembly, according to embodiments of the present invention.

To achieve the above and/or other aspects and advantages, embodiments of the present invention include a recording and/or reproducing method, including supporting a read/write head for a medium, and manipulating the supporting of the read/write head to record and/or reproduce data to/from the medium, wherein the manipulation of the supporting of the read/write head is performed through movement of a swing arm, with the swing arm further including a load beam and a flexure coupled to the swing arm, such that the flexure supports the read/write head by having a freedom of movement separate from the load beam and prevents contact of the flexure with the load beam through a force application between the flexure and the load beam by applying a force to the flexure only at a predetermined position on the flexure.

The force application between the flexure and the load beam may be performed by a dimple formed on the flexure.

To achieve the above and/or other aspects and advantages, embodiments of the present invention include a read/write head support method, including supporting a read/write head with a swing arm, with the swing arm further including a load beam and a flexure coupled to the swing arm, such that the flexure supports the read/write head to have a freedom of movement separate from the load beam and prevents contact of the flexure with the load beam through a force application between the flexure and the load beam applying a force to the flexure only at a predetermined position on the flexure.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a partial perspective view of a conventional disk drive;

FIGS. 2A and 2B illustrate a vertical sectional view of a suspension assembly of the conventional disk drive shown in FIG. 1 when a dimple and a flexure normally contact each other;

FIG. 3A and 3B illustrate a vertical sectional view of the suspension assembly of the conventional disk drive shown in FIG. 1 when a contact position between the dimple and the flexure is changed;

FIG. 4 illustrates a perspective view of an actuator including a suspension assembly of a disk drive, according to an embodiment of the present invention;

FIG. 5 illustrates a perspective view of a slider in a state where the slider flies above a disk;

FIG. 6 illustrates a side view of the flying slider shown in FIG. 5;

FIG. 7 illustrates a rear view of the flying slider shown in FIG. 5;

FIG. 8 illustrates a side view of a flying slider at static equilibrium with new attitudes when a contact position of a dimple changes in a longitudinal direction of the slider;

FIGS. 9 through 11 graphically illustrate simulation results for variations in a flying height, a pitch angle, and a roll angle in the static equilibrium of the slider shown in FIG. 8;

FIG. 12 illustrates a rear view of a flying slider at static equilibrium with new attitudes when a contact position of the dimple changes in a transverse direction of the slider;

FIGS. 13 through 15 graphically illustrate simulation results showing variations in a flying height, a pitch angle, and a roll angle of the slider shown in FIG. 12; and

FIG. 16 illustrates a vertical sectional view of a suspension assembly of a disk drive, such as that shown in FIG. 4, according to embodiments of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below to explain the present invention by referring to the figures.

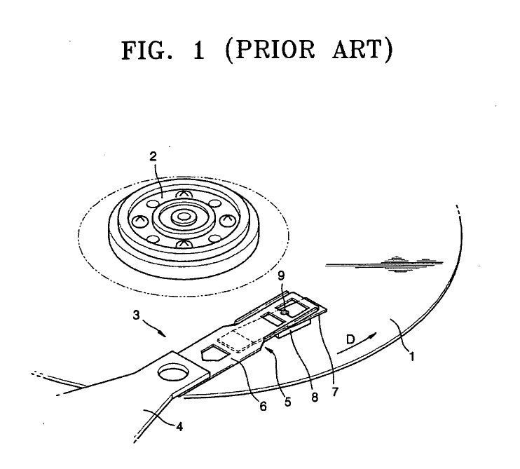

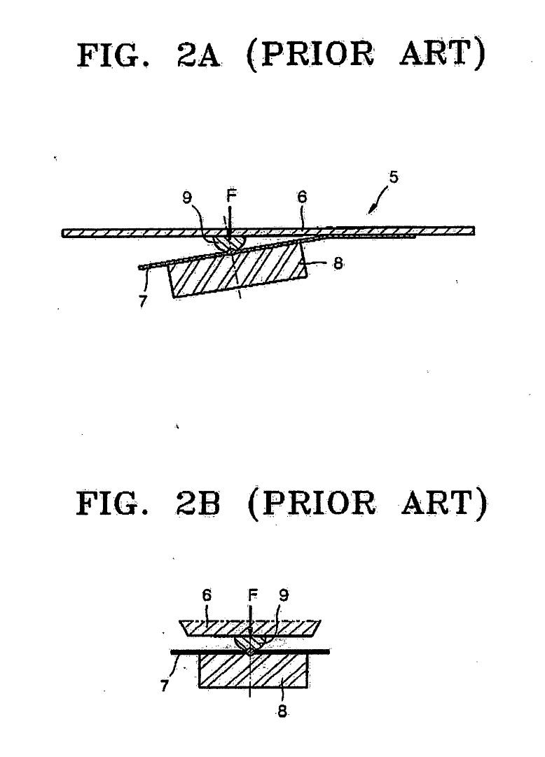

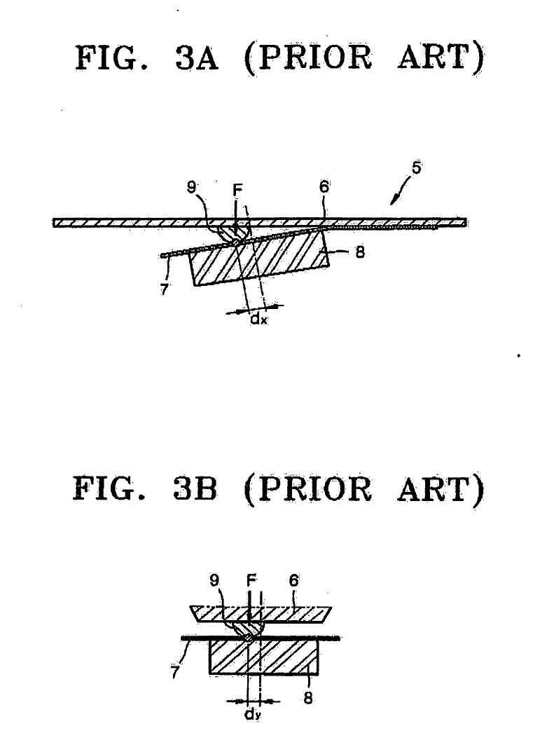

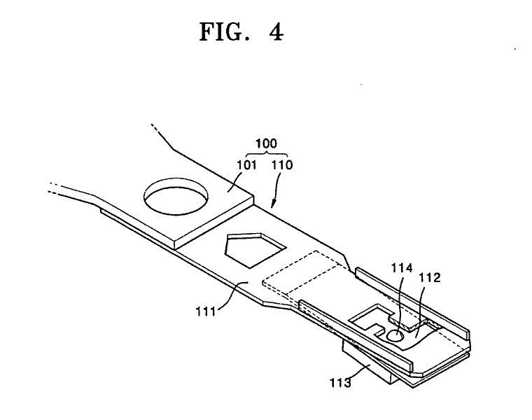

FIG. 4 illustrates a perspective view of an actuator including a suspension assembly for disk drive, such as that shown in FIG. 1, according to an embodiment of the present invention.

Referring to FIG. 4, an actuator 100 may include a suspension assembly 110 to move a read/write head (not shown) for recording and/or reproducing data to/from a desired position on the disk.

In detail, the actuator 100 may include a swing arm 101, rotating from a rotational force produced by a voice coil motor (VCM, not shown), with the suspension assembly 110 installed at one end of the swing arm 101. The suspension assembly 100 may elastically bias an air bearing slider 113, on which the read/write head is mounted, toward a surface of the disk.

In further detail, the suspension assembly 110 may include a load beam 111, a flexure 112, and the air bearing slider 113.

The load beam 111 can be coupled to the one end of the swing arm 101. In addition, the load beam 111 may also be generally made by pressing a thin metal plate, such as a stainless steel sheet, with a thickness of approximately 0.05 mm, for example.

The flexure 112 can be attached to a bottom surface of the load beam 111 facing the disk, and supports the slider 113. The flexure 112 can have one end fixed to the bottom surface of the load beam 111, facing the disk, and the other end extending toward an end of the load beam 111 to move somewhat freely. The flexure 112 can be made of the same stainless steel sheet as the load beam 111. However, to ensure free roll and pitch motions of the slider 113 attached to a rear surface of the flexure 112, the flexure 112 may have a thickness of approximately 0.02 mm less, for example, than the thickness of the load beam 111.

The slider 113 flies at a predetermined height above the surface of the disk due to a lifting force produced during the rotation of the disk maintaining a predetermined distance between the head and the surface of the disk.

Further, a dimple 114 can be made to protrude a predetermined distance from the flexure 112, toward the load beam 111. The dimple 114 provides a predetermined elastic force to the flexure 112. In this structure, the flexure 112 can somewhat move freely, such that the slider 113 has smooth roll and pitch motions

Since the dimple 114 is formed on the top surface of the flexure 112, facing the load beam 111, the dimple 114 is prevented from shifting the applied force to the flexure 112, such that the flying stability of the slider 113 is increased.

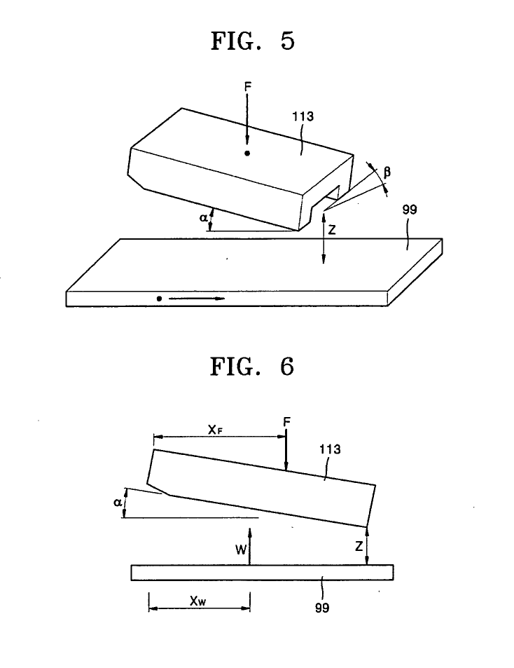

Below, basic concepts of the suspension assembly of the disk drive, according to an embodiment of the present invention, will be explained further with reference to FIGS. 5 through 15, with the suspension assembly being further explained with reference to FIG. 16.

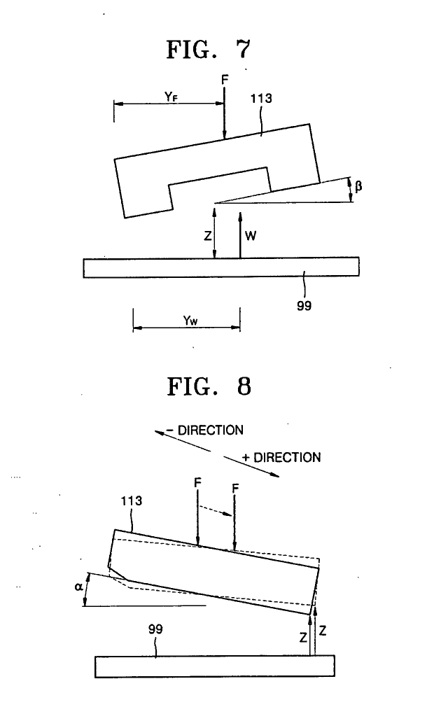

FIG. 5 illustrates a perspective view of a slider in a state where the slider flies above the disk. FIG. 6 is a side view of the flying slider shown in FIG. 5, and FIG. 7 is a rear view of the flying slider shown in FIG. 5.

Referring to FIGS. 5 through 7, the slider 113 can fly at a predetermined height above the surface of the disk 99 due to a lifting force produced from the rotation of the disk 99.

Here, F is a Gram load applied from the suspension assembly 110 through a dimple, X_{F} and Y_{F} are loading positions in the X-direction and the Y-direction of the load F, respectively, taken from a reference point to the point of action of the force F, W is a load carrying capacity (net force) produced according to a rotation of the disk 99 lifting the slider 113, X_{W} and Y_{W} are pressure centers in the X-direction and the Y-direction, respectively, taken from a reference point to the point of action of the load carrying capacity W, Z is the flying height of the slider 113 above the surface of the disk 99, and α and β are pitch and roll angles, respectively.

Force/moment equilibrium equations of the flying slider 113 are shown below, with Equation 1 being a force equilibrium equation, Equation 2 being a moment equilibrium equation, and Equation 3 being another moment equilibrium equation.
F=F−W=0 (1)
M_{α}=X_{F}·F−X_{W}·W=0 (2)
M_{β}=Y_{F}·F−Y_{W}·W=0 (3)

Referring to the force/moment equilibrium equations, the movement of the slider 113 can be determined by the flying height, the pitch angle, and the roll angle. In a static equilibrium, force/moment equilibriums of the three factors are achieved.

If the size or position of at least one of the three factors satisfying the force/moment equilibrium equations is changed, the slider 113, with new attitudes, will come to a new static equilibrium, which will now be further explained.

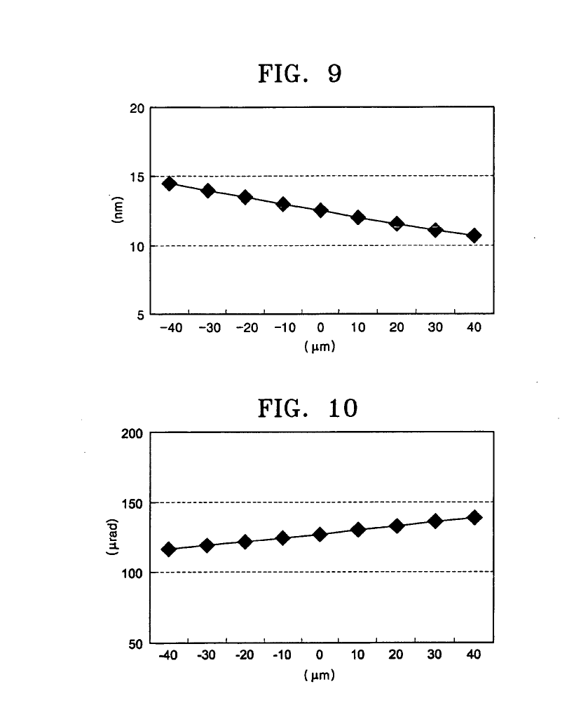

FIG. 8 illustrates a side view of a slider at static equilibrium with new attitudes when the contact position of the dimple changes in a longitudinal direction of the slider. FIGS. 9 through 11 graphically illustrate simulation results for variations in a flying height, a pitch angle, and a roll angle in the static equilibrium of the slider shown in FIG. 8.

Here, in FIG. 8, the portion marked with a dotted line represents the state before the contact position of the dimple changed, and the portion marked with the solid line represents the state after the contact position of the dimple changed.

Referring to FIGS. 8 through 11, if the position of the dimple 11 changes in a longitudinal direction of the slider 113, in the range of −40 μm to +40 μm, the point of action for the force F also changes based on to the new contact position of the dimple 114.

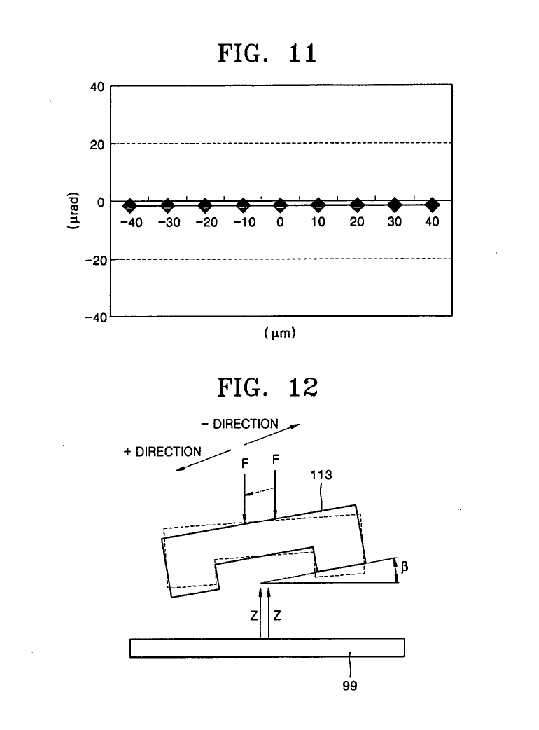

When the point of action of the force F changes in this way, the flying height of the slider 113 decreases, as shown in FIG. 9, and the pitch angle increases, as shown in FIG. 10. However, in this situation, although the point of action of the force F changed, the roll angle of the slider 113 may rarely change, as shown in FIG. 11

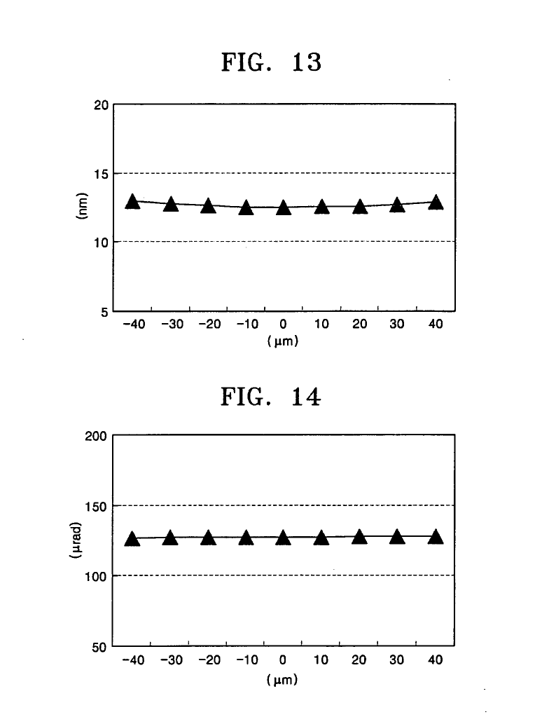

FIG. 12 is a rear view of a slider at static equilibrium with new attitudes when the contact position of the dimple changes in a transverse direction of the slider. FIGS. 13 through 15 graphically illustrate simulation results for variations in a flying height, a pitch angle, and a roll angle, respectively, in the static equilibrium of the slider shown in FIGS. 12.

Referring to FIGS. 12 through 15, if the contact position of the dimple 114 changes in a transverse direction of the slider 113, in the range of −40 μm to +40 μm, the point of action of the force F also changes corresponding to the new contact position of the dimple 114.

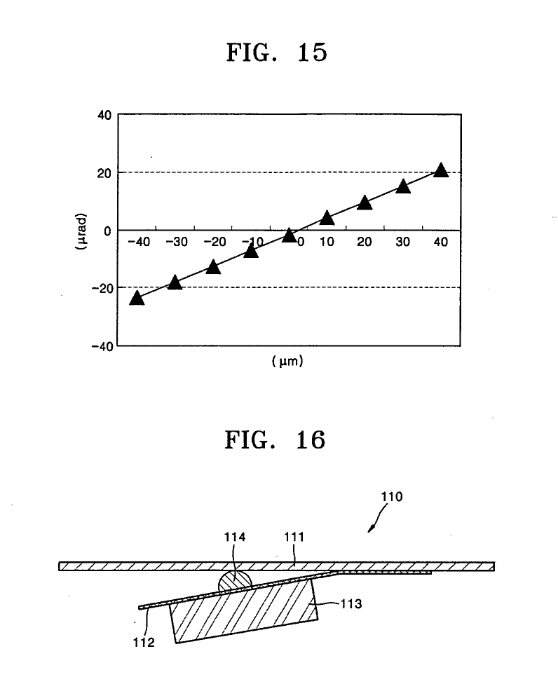

When the point of action of the force F changes in this way, the roll angle of the slider 113 increases as shown in FIG. 15. However, in this situation, although the point of action of the force F changed, the flying height and the pitch angle of the slider 113 may rarely change, as shown in FIGS. 13 and 14, respectively.

Thus, as shown in FIGS. 8 through 15, in general, if the contact position of the dimple 114 changes in the longitudinal direction of the slider 113, the flying height Z and the pitch angle a of the slider 113 greatly change. If the contact position of the position of the dimple 114 changes in the transverse direction of the slider 113, the roll angle β of the slider 113 greatly changes. Accordingly, if the contact position of the dimple 114 changes, the flying height, the pitch angle, and the roll angle of the slider 113 are also changed. The flying attitudes of the slider 113 are also changed. Such changes in the attitudes of the slider 113 hinder the slider 113 from flying and moving smoothly, and/or cause a conflict between the head and the disk, thereby reducing the flying stability of the slider 113. Accordingly, if the contact position of the dimple 114, relative to the slider 113, is maintained relatively constant these deficiencies can be avoided.

According to embodiments of the present invention, if the dimple 114 is formed on the surface of the flexure 112, facing the load beam 111, the dimple 114 moves together with the slider 113 and the flexure 112, thereby sharing the same path, i.e., moving coincidently. Accordingly, in embodiments of the present invention, a position of the dimple 114 relative to the slider 113 and the flexure 112 may be kept constant.

With this in mind, FIG. 16 illustrates a vertical sectional view of a suspension assembly, e.g., for a disk drive such as that shown in FIG. 4.

Referring to FIG. 16, the suspension assembly 110 may include the load beam 111, the flexure 112 mounted on the rear surface of the load beam 111, and the slider 113 mounted on the surface of the flexure 112 facing the disk 99. The dimple 114 can be formed on the surface of the flexure 112, facing the load beam 111.

The dimple 114 provides a predetermined elastic force to the flexure 112 such that smooth roll and pitch motions of the slider 113, attached to the flexure 112, can be accomplished. Since the contact area between the dimple 114 and the load beam 111 should be minimal, preferably, though not limited thereto, it is preferable that the dimple 114 has a circular or oval vertical cross-section with a predetermined curvature, and that the dimple 114 and the load beam 111 are in a point-contact relation.

Furthermore, to increase a flying stability of the slider 113, an initial position of the dimple 114 relative to the flexure 112 and the slider 113 should not be changed even if the dimple 114 often contacts with an opponent surface, e.g., the load beam, due to external shocks or the like.

According to an embodiment of the present embodiment, the dimple 114 can be formed on the flexure 112 and moves coincidently together with the flexure 112 to share the same path. Accordingly, position relations among the flexure 112, the slider 113 fixed to the flexure 112, and the dimple 114 can be maintained constant. Consequently, even though the dimple 114 may contact portions on a facing surface of the load beam 12, the point of action of a force applied to the slider 113, via the dimple 114, can be always coincident with the central portion, for example, of the slider 113. Since the moment of force applied to the slider 113 may be maintained constant throughout contacts with the load beam 12, the flying height, the pitch angle, and the roll angle of the slider 113 can be maintained. As a result, attitudes of the slider 113 can be kept constant, and thus, the flying stability of the slider 113 increased. Also, the slider 113 can fly and move smoothly, further preventing damage to the head and the disk.

Moreover, according to an embodiment of the present invention, to more firmly fix an initial position of the dimple 114, relative to the flexure 112 and the slider 113, the dimple 114 may be integrally formed with the flexure 112 or separately formed from the flexure 112 and then fixed to the flexure 112, noting that additional embodiments are also available.

As described above, since the dimple is formed along the surface of the flexure, which supports the slider, facing the load beam, the contact position of the dimple does not change even if the dimple often contacts the load beam, e.g., due to external shocks or the like. Accordingly, since the point of action of a force does not change, attitudes of the slider can be kept constant, thereby increasing the flying stability of the slider.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A suspension assembly for a recording and/or reproducing apparatus, to be installed on a swing arm to elastically bias an air bearing slider with a read/write head thereon toward a surface of a medium, the suspension assembly comprising:
a load beam coupled to the swing arm;
a flexure, coupled to the load beam and supporting the slider, having freedom of movement separate from the load beam, with the flexure comprising a dimple; and
the dimple being on a surface of the flexure, separate from the load beam, facing the load beam.

2. The suspension assembly of claim 1, wherein the dimple protrudes a predetermined height from the surface of the flexure toward the load beam.

3. The suspension assembly of claim 1, wherein the dimple comprises a vertical section with a predetermined curvature.

4. The suspension assembly of claim 3, wherein the dimple comprises a vertical section that is semi-circular or semi-oval.

5. The suspension assembly of claim 1, wherein, upon movement of the flexure, the dimple is point-contactable with the load beam.

6. The suspension assembly of claim 1, wherein the dimple is integrally formed with the flexure.

7. The suspension assembly of claim 1, wherein the dimple is separate from an integral structure of the flexure, but fixed to the flexure.

8. The suspension assembly of claim 1, wherein the recording and/or reproducing apparatus is a disk drive and the medium is a disk.

9. A suspension assembly for a recording and/or reproducing apparatus, comprising:
a load beam disposed on a swing arm;
a flexure, coupled to the load beam, having freedom of movement separate from the load beam;
an air bearing slider, disposed on the flexure, comprising a read/write head; and
a dimple, separate from the load beam, coincidently moving with the slider, such that a position relation between the dimple and the slider is maintained constant.

10. The suspension assembly of claim 9, wherein the dimple coincidently moves with the flexure and the slider.

11. The suspension assembly of claim 10, wherein the dimple and the slider are fixed to the flexure to enable the coincident movement of the dimple, slider, and flexure.

12. The suspension assembly of claim 9, wherein the dimple is integrally formed with the flexure.

13. The suspension assembly of claim 9, wherein the dimple is separate from an integral structure of the flexure, but fixed to the flexure, facing the load beam.

14. The suspension assembly of claim 9, wherein the dimple protrudes a predetermined height from the flexure toward the load beam.

15. The suspension assembly of claim 9, wherein the dimple has a vertical section with a predetermined curvature.

16. The suspension assembly of claim 9, wherein the dimple has a vertical section that is substantially semi-circular or semi-oval.

17. The suspension assembly of claim 9, wherein the dimple is point-contactable with a surface of the load beam.

18. The suspension assembly of claim 9 wherein the recording and/or reproducing apparatus is a disk drive.

19. A recording and/or reproducing apparatus, comprising:
a medium;
a read/write head to record and/or reproduce data to/from the medium; and
the suspension assembly of claim 1.

20. A recording and/or reproducing apparatus, comprising:
a medium;
a read/write head to record and/or reproduce data to/from the medium; and
the suspension assembly of claim 9.
